(19) United States
(12) Patent Application Publication
(10) Pub. No.: US 2026/0132619 A1
(43) Pub. Date: May 14, 2026

(54) HOLDER FOR FASTENING A LOAD TO A DRY-CONSTRUCTION STRUCTURE, A KIT AND A DRY-CONSTRUCTION STRUCTURE COMPRISING SUCH A HOLDER, AND A METHOD OF FASTENING LOADS TO A DRY-CONSTRUCTION STRUCTURE

(71) Applicant: KNAUF GIPS KG, Iphofen (DE)

(72) Inventor: Zhirayr BADVAGANYAN, Plovdiv (BG)

(21) Appl. No.: 19/118,485

(22) PCT Filed: Nov. 22, 2022
(86) PCT No.: PCT/EP2022/025528

§ 371 Date: Apr. 4, 2025

(51) Int. Cl. E04B 2/74; F16B 5/02

(52) U.S. Cl. CPC E04B 2/7457; F16B 5/02

(57) ABSTRACT

A holder for fastening a load to a dry-construction structure, including a connecting body and a bolt, wherein the connecting body has a first and a second side, wherein an abutment surface for abutting against a dry-construction stud is formed on the first side of the connecting body, wherein a bolt receptacle for the bolt is provided on the second side of the connecting body is disclosed. The disclosure further relates to a kit including such a holder and to a dry-construction structure including such a holder. The disclosure also relates to a method of fastening loads to a dry-construction structure.

The invention relates to a holder for fastening a load to a dry-construction structure. The holder is particularly suitable for fastening loads to a dry-construction wall, such as in particular a partition wall or a facing shell. However, the holder can also be used for fastening loads to other dry-construction structures. In addition, the invention relates to a kit comprising such a holder and a dry-construction structure comprising such a holder. Furthermore, the invention comprises a method of fastening loads to a dry-construction structure, in particular a dry-construction wall.

A dry-construction structure has a substructure with dry-construction studs to which a planking is fastened. In principle, it is possible to fasten loads that are not too heavy directly to the planking. In this respect, it is known to attach loads with nails. When using so-called X-hooks which are fastened to the planking with nails, loads of 5 kg to 15 kg per hook can typically be fastened, depending on the design. Furthermore, it is known to attach loads with screws which are inserted directly into the planking. Here, loads of up to about 13 kg per screw can be fastened to a single-layer planking. In the case of two-layer planking with customary planking panels made of gypsum plasterboard, it may be possible to fasten up to 40 kg per screw under certain circumstances. The values can be increased to 50 kg up to 60 kg per screw when using suitable cavity dowels. The loads that can be achieved in each case also depend on the type of planking. When using particularly stable planking panels, the loads can be increased to some extent.

However, for many fastenings, the above values are not sufficient. This applies in particular to so-called console loads. Console loads are usually secured via several fastening points to the wall. Examples of console loads are hanging-mounted cabinets, hanging-mounted shelves, or other hanging-mounted objects such as water heaters, heating systems or the like. Console loads have a so-called eccentricity, wherein the eccentricity describes the distance of the load resultants to the wall surface. The eccentricity must be taken into account when determining the load-bearing capacity. The greater the eccentricity, the smaller the console loads to be fastened must be for a selected fastening. The maximum permissible console loads are often specified for eccentricities of up to 300 mm. This corresponds, for example, to a uniformly loaded cabinet with a depth of 600 mm.

In order to be able to attach higher loads, it has already been suggested to use traverses for fastening which are arranged at the back of the planking. The traverses are arranged between two dry-construction studs. There are known traverses that comprise a multi-layered wooden panel on which steel sheet profiles are arranged. The traverse can be connected to the dry-construction studs via the sheet steel profiles. Furthermore, there are traverses known which have a metal plate. Loads can be fastened in each case with screws inserted through the planking into the traverse. Traverses can typically be used to attach loads of up to 150 kg per metre of wall surface.

It is an object of the invention to specify a holder, a kit and a dry-construction structure which allow higher loads to be easily and securely fastened to a dry-construction structure without the need for traverses. Furthermore, the invention has the task of specifying a method of fastening a load to a dry-construction structure.

The object is solved with the characteristics of claim 1. Accordingly, a holder for fastening a load to a dry-construction structure is provided having a connecting body and a bolt, wherein the connecting body has a first and a second side, wherein an abutment surface for abutting against a dry-construction stud is formed on the first side of the connecting body, wherein a bolt receptacle for the bolt is provided on the second side of the connecting body. This design allows forces from loads to be transferred directly into the substructure. This applies to both, static and dynamic forces. In particular, console loads can also be securely fastened which are preferably connected to the dry-construction structure via several fastening points. One of the holders can be provided at each fastening point. Despite the eccentricity of console loads, i.e., the considerable distance between the load resultants and the wall surface, loads can be securely fastened. This is helped by the fact that the forces can be transferred directly into the dry-construction stud via the holder. Therefore, the forces do not have to be absorbed by the planking or they have to be absorbed by it to a much lesser extent. The mounting of the holder can be done in a time-saving and secure manner. In addition, the holders allow for great flexibility with regard to the exact height of the fastening, as the holders can be fastened to the dry-construction stud at different heights. Fastening with the holder is also cost-effective, as it only needs to be provided at locations where a load is to be fastened. The holder is flexible in its handling and can be installed by the fitter in the required places.

In the following, preferred embodiments are described which further improve the advantages described above.

An advantageous embodiment of the invention provides that the bolt receptacle has an opening for the bolt. The bolt can be inserted into the opening and connected to the connecting body in this way. This way, a reliable fastening of loads can be achieved. Preferably, the opening extends through the bolt receptacle.

A preferred embodiment provides that the bolt has a longitudinal bolt axis and that the longitudinal bolt axis is arranged parallel to the second side. The bolt can be arranged with a distance to the second side. Preferably, this distance is between 0.2 times and 0.9 times the bolt diameter of the bolt.

A preferred embodiment of the invention provides that the bolt has an external thread, and the bolt receptacle has an internal thread corresponding to the external thread. The internal thread can be formed to engage with the external thread of the bolt. In this way, the bolt can be connected to the bolt receptacle by screwing the bolt in.

According to the invention, it is particularly preferred that the bolt receptacle is formed by an annular body which is secured to the connecting body. In particular, the annular body can be designed as a screw nut. Preferably, the screw nut has a hexagonal shape on its circumference. This contributes to a reliable fastening of loads and also enables easy manufacture.

A preferred embodiment provides that the bolt receptacle is secured to the connecting body with a material bond. Preferably, the bolt receptacle is welded to the connecting body.

An advantageous embodiment provides that the holder is associated with a first fastening element for connecting the connecting body to the dry-construction stud. The first fastening element can be used to securely connect the connecting body and the dry-construction stud. In this way, any forces that occur can be safely transferred into the dry-construction stud.

Advantageously, it can be provided that the first fastening element can comprise at least one screw with a screw thread. This allows to brace the connecting body to the dry-construction stud. Preferably, the screw has an enlarged head. It may be provided that the first fastening element comprises at least one nut which, via its nut thread, can be engaged with the screw thread.

A secure fastening is achieved if the bolt is made of metal. Preferably, the bolt is made of steel.

According to the invention, it may further be provided that the bolt has a circular cross-section.

Preferably, the connecting body comprises a connecting plate. It is preferred if the connecting plate is a flat plate. Preferably, the connecting body has a rectangular basic shape.

According to the invention, it is preferred if the connecting body is made of metal. Preferably, the connecting body is made of sheet metal.

Preferably, the abutment surface is a flat surface.

According to a further improvement, it may be provided that the connecting body comprises at least one through-opening for the first fastening element. Preferably, the connecting body has at least two through-openings. A first fastening element can then be inserted through each of the through-openings.

The invention further relates to the use of the described holder for securing a load to a dry-construction structure, in particular a dry-construction wall. In particular, the holder can be used for securing a console load to a dry-construction wall.

The underlying object of the invention is further solved by a kit for a dry-construction system comprising a dry-construction stud, wherein the kit further comprises the described holder.

According to the invention, it is preferred if the dry-construction stud has a profiled body with a web and at least one leg. Such dry-construction elements like studs with a respective profiled body are herein also shortly referred to as ‘profile’. Preferably, the profiled body has a web with two legs. In particular, the profiled body can be U-shaped (so called U-profile). It is particularly preferred if the profiled body is formed as a U-stiffening profile, i.e. as a U-shaped, reinforced profiled body.

A preferred embodiment provides that the web has insertion openings for the first fastening elements. Preferably, the insertion openings are formed as slots or oblong holes. This contributes to a safe introduction of forces and also enables height adjustment.

A preferred embodiment provides that a lower edge of the insertion opening forms a support for the first fastening element. In this way, forces (especially vertical forces) can be introduced directly into the dry-construction stud.

Preferably, the profiled body is made of sheet metal. In particular, the sheet metal can be galvanised.

Preferably, the sheet metal of the profiled body has a sheet thickness between 1 mm and 5 mm. A sheet thickness between 1.5 mm and 2.5 mm is particularly preferred.

Preferably, the dry-construction stud is formed as a dry-construction support. The dry-construction support can be arranged vertically in particular.

The kit can further comprise a dry-construction board for fastening to the dry-construction stud. Preferably, the dry-construction board is a gypsum board, a gypsum plasterboard, a gypsum fibreboard, a cement board, a wood board, or a wood fibreboard.

The underlying task of the invention can further be solved by a dry-construction structure comprising at least one dry-construction stud as well as a planking fastened thereto, wherein the planking has a front side and a rear side, wherein the dry-construction stud is arranged at the rear side of the planking, wherein one of the described holders is provided and fastened to the dry-construction stud by means of a first fastening element, wherein the bolt of the holder extends through the planking from the rear side to the front side.

Thereby, it can be provided that the first fastening element extends through the through-opening in the holder and the insertion opening in the dry-construction stud to secure the holder to the dry-construction stud.

In particular, the dry-construction structure can be arranged in such a way that the front side faces towards a room and that the rear side faces away from the room.

Preferably, the dry-construction structure is designed as a partition wall or a facing shell. In the case of a partition wall, the dry-construction stud can be provided with planking on both sides. A facing shell can be arranged in front of a wall, wherein the dry-construction studs have planking on the side facing away from the wall.

Preferably, the dry-construction stud is a vertically arranged dry-construction support. The longitudinal direction of the dry-construction support can extend in a vertical direction.

Furthermore, it can be advantageously provided that the at least one dry-construction support extends over the entire height of the dry construction structure (in particular of the partition wall or facing shell).

A preferred embodiment of the invention provides that the bolt has a section that protrudes by a length A at the front of the planking. Preferably, the length A is between 10 mm and 30 mm, wherein a length A of more than 15 mm and/or less than 25 mm is particularly preferred.

Preferably, the bolt has a length between 60 mm and 100 mm.

Preferably, the bolt has a diameter between 10 mm and 15 mm.

A preferred embodiment provides that the planking has a recess, wherein the bolt extends through said recess.

Preferably, the thickness of the planking is 25 mm or less.

A preferred embodiment provides that the recess in the area surrounding the bolt is at least partially filled with a fill material. Preferably, the fill material contains a silicone.

The underlying task of the invention is further solved by a method of fastening an object to a dry-construction structure comprising a dry-construction stud and a planking, comprising the steps of:
fastening a described holder to the dry-construction stud;
creating a recess in the planking;
arranging the planking on the dry-construction stud;
   wherein this is done in such a way that the bolt of the holder extends through the recess of the planking and wherein the object is fastened to the bolt.

Preferably, in order to obtain several fastening points, it is provided that holders are fastened each to one of a plurality of several dry-construction studs.

Furthermore, it is preferred if the holder is fastened to the dry-construction stud before the planking is arranged on the dry-construction stud. However, the assembly can also be carried out in a different order.

In particular, the object to be fastened can form a console load. Preferably, the object is a piece of furniture, such as in particular a hanging shelf or a hanging cabinet, a sanitary appliance, or a component of a heating system.

Further goals, characteristics, advantages, and application possibilities of the present invention result from the following description of exemplary embodiments based on the drawings. All described and/or depicted characteristics, individually or in any meaningful combination, form the object of the invention, even independently of the summary in individual claims or their referrals.

The drawings show:

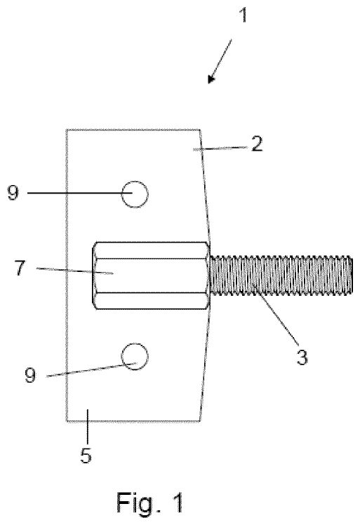

FIG. 1: a holder for fastening a load to a dry-construction structure;

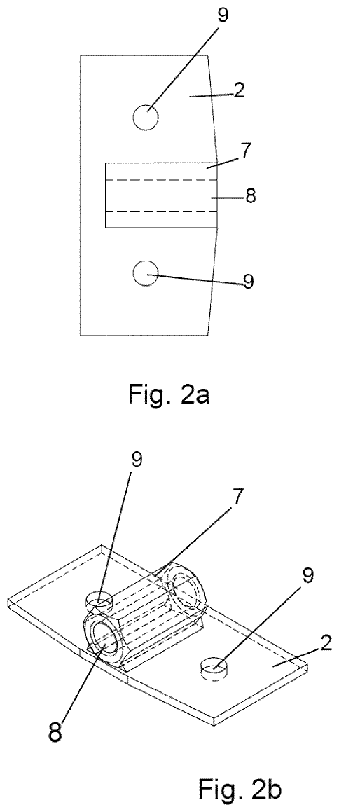

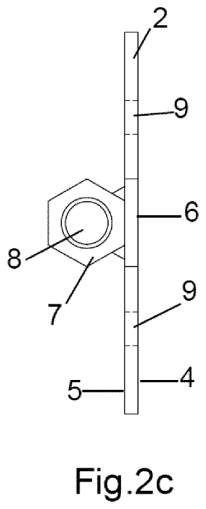

FIG. 2a: a top view of the connecting body of the holder from FIG. 1;

FIG. 2b: a perspective depiction of the connecting body from FIG. 1;

FIG. 2c: a side view of the connecting body from FIG. 1;

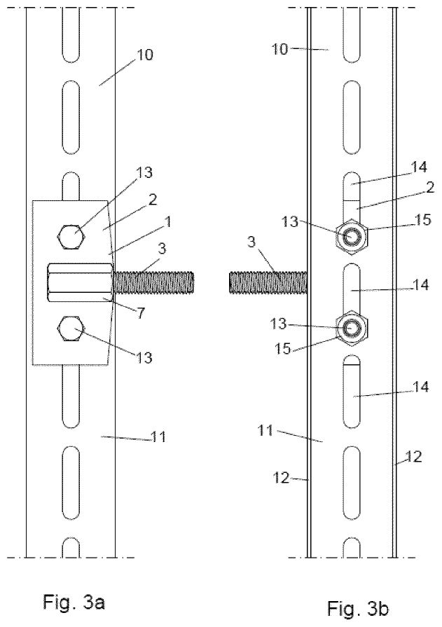

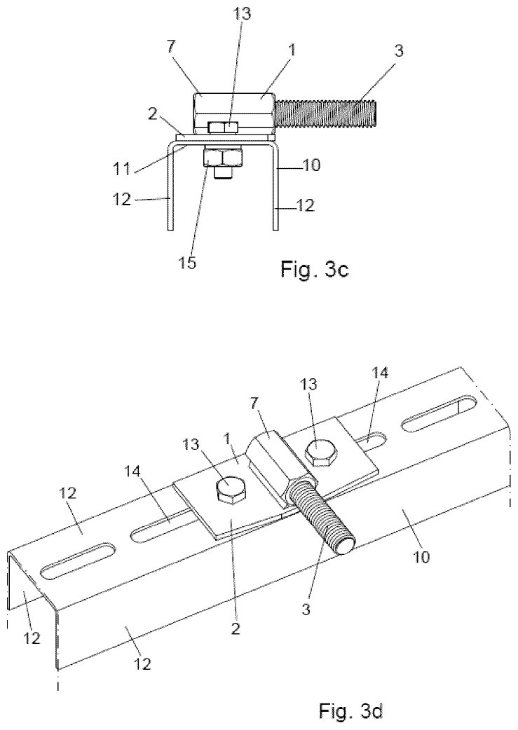

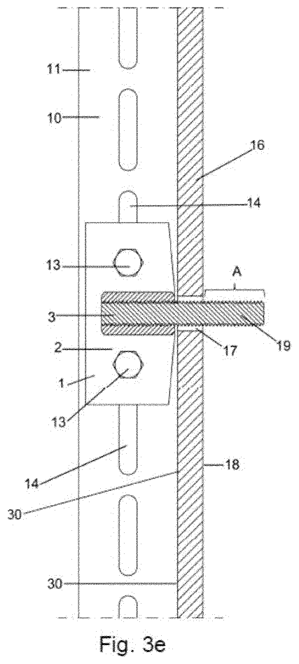

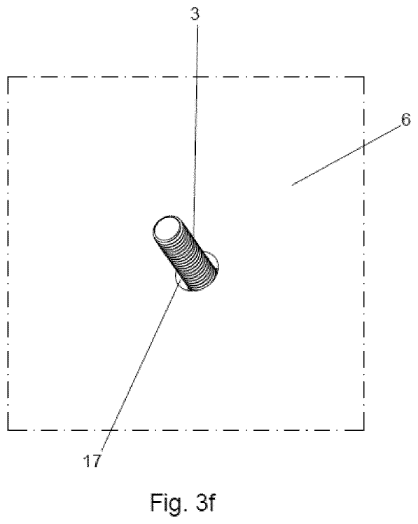

FIG. 3a: a side view of a dry-construction stud of a dry-construction structure with a holder from FIG. 1 fastened thereto from a first side;

FIG. 3b: a side view of the dry-construction stud of the dry-construction structure from FIG. 3a from a second side;

FIG. 3c: a top view of the dry-construction stud with the holder from FIG. 3a fastened thereto;

FIG. 3d: a perspective view of a section of the dry-construction stud with a holder from FIG. 3a fastened thereto;

FIG. 3e: the dry-construction stud from FIG. 3a with a planking arranged on the dry-construction stud;

FIG. 3f: a perspective view in cutout of the dry-construction structure from FIG. 3e;

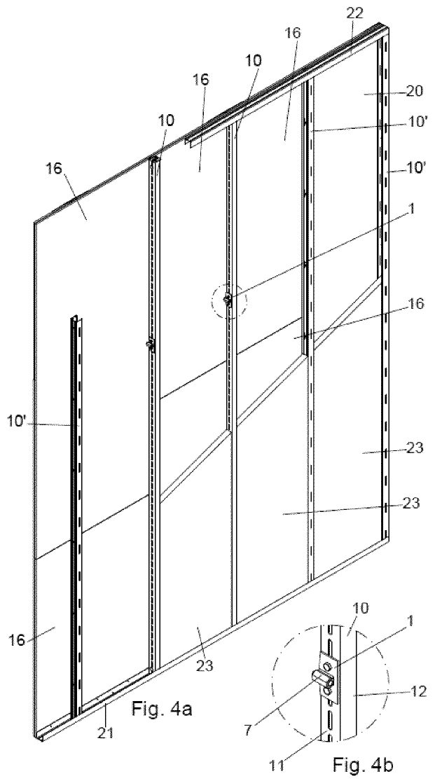

FIG. 4a: a schematic perspective representation, partly in section, of a dry-construction structure with holders according to FIG. 1;

FIG. 4b: an enlarged detail of the dry-construction structure from FIG. 4a;

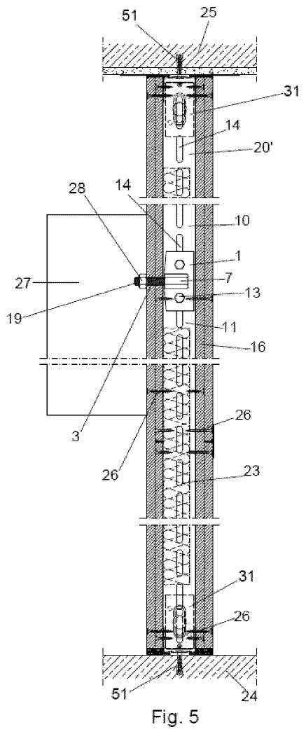

FIG. 5: a schematic sectional representation of a dry-construction structure formed as a partition wall.

FIG. 1 shows a holder 1 for fastening a load to a dry-construction structure that is not depicted.

The holder 1 has a connecting body 2 and a bolt 3. The connecting body 2 is shown in more detail in the FIGS. 2a to 2c. The connecting body 2 has a first side 4 and a second side 5. A flat abutment surface 6 is formed on the first side 4 for abutment to a dry-construction stud. On the second side 5, the connecting body has a bolt receptacle 7 for the bolt 3. The bolt receptacle 7 has an opening 8 into which the bolt is inserted and connected to the connecting body 2. As depicted, the opening 8 can extend through the bolt receptacle 7.

For fastening, the bolt 3 has an external thread, while the bolt receptacle 7 has an internal thread corresponding to the external thread. In this way, the bolt 3 can be easily and securely connected to the bolt receptacle 7 by screwing it into the latter. In addition, a load can be fastened to the bolt 3 via the external thread.

The FIGS. 1 to 2c further show that the bolt 3 in the depicted exemplary embodiment is arranged with its longitudinal bolt axis parallel to the second side 5. Furthermore, it can be seen that the bolt 3 is arranged at a distance from the second side 5.

As depicted, the bolt receptacle 7 is formed by an annular body. In the depicted exemplary embodiment, the annular body is formed as a screw nut with an internal thread. The screw nut has a hexagonal shape on its circumference, as can be seen in particular in FIG. 2c.

The connecting body 2 and the bolt receptacle 7 are made of metal. The connecting body 2 can in particular be made of sheet metal. The bolt receptacle 7 is fastened to the connecting body 2 with a material bond by welding.

The connecting body 2 is formed as a connecting plate. In the depicted exemplary embodiment, the connecting body 2 has a rectangular basic shape.

Through-openings 9 are provided in the connecting body 2. In the depicted exemplary embodiment, two through-openings 9 are provided. Through the through-openings 9, first fastening elements can be inserted into an element of the dry-construction structure, which will be explained further below.

The bolt 3 can in particular be made of metal, preferably steel. The bolt 3 has a circular cross-section.

The FIGS. 3a to 3f show the holder 1 fastened to a dry-construction stud 10 of a dry-construction structure in different views.

The dry-construction stud 10 is a dry-construction profile having a web 11 and two legs 12 arranged on the web 11. In the depicted exemplary embodiment, the dry-construction stud is formed as a U-profile. In particular, the dry-construction stud 10 can be designed as a U-stiffening profile. The nominal sheet thickness of the U-profile can in particular be between 1 and 5 mm.

FIG. 3a shows a side view of the dry-construction stud 10 from a first side. Here, the view onto the external side of the web 11 of the U-shaped dry-construction stud 10 is depicted. FIG. 3b shows a side view of the dry-construction stud 10 from a second side. Here, a view from the opposite side, i.e., onto the internal side of the web 11, from the side to which the legs 12 of the dry-construction stud extend, is depicted.

The FIGS. 3a and 3b further show the first fastening elements 13 for connecting the connecting body 2 to the dry-construction stud 10. In the depicted exemplary embodiment, two first fastening elements 13 are provided. These each comprise screws that extend through one of the through-openings 9 in the connecting body 2. The screws have an enlarged head and shank.

The FIGS. 3a and 3b further show that the dry-construction stud 10 has insertion openings 14 in the web 11 for the first fastening elements 13. As depicted, the insertion openings 14 are designed as slots or oblong holes. In this case, a lower edge of the insertion opening 14 can form a support for the first fastening element 13. Accordingly, as can be seen in FIG. 3i b, the first fastening elements 13 are each arranged at the lower end of an insertion opening 14.

FIG. 3b further shows that the first fastening elements 13 comprise nuts 15 which are engaged with their nut thread with the screw thread of the screw of the first fastening element 13. In this way, the holder 1 can be braced to the dry-construction stud 10.

FIG. 3c shows a top view of the dry-construction stud 10 with the holder 1 fastened thereto. The figure clearly shows the U-shape of the dry-construction stud 10 with the web 11 and the two legs 12. In addition, it is depicted how the holder 1 is fastened to the dry-construction stud 10 by the fastening elements 13.

FIG. 3d shows a perspective depiction of the holder 1 fastened to the dry-construction stud 10.

FIG. 3e shows the dry-construction stud 10 of FIG. 3a schematically with a planking 16 fastened thereto. In particular, the planking 16 can comprise gypsum boards, gypsum plasterboards, gypsum fibreboards, cement boards, wood boards or wood fibreboards. In FIG. 3e, a single-layer planking 16 is depicted in a schematic manner.

The planking 16 has a recess 17. The bolt 3 extends through the recess 17 of the planking 16. The planking 16 has a front side 18 facing the room and a rear side 30 facing away from the room. At the front side of the planking 16, the bolt 3 protrudes with a section 19 by the length A. A load can be securely fastened to section 19. Section 19 is also well depicted in FIG. 3f.

The recess 17 around the bolt 3 can be filled with a preferably elastic fill material, such as silicone (not depicted).

FIG. 3f shows a perspective view of the planking 16 of the dry-construction structure from FIG. 3e. Here, it can be clearly seen that the bolt 3 protrudes in relation to the planking 16.

FIG. 4a shows a schematic perspective representation of a dry-construction structure 20. The dry-construction structure 20 has multiple dry-construction studs 10, 10′ that are arranged spaced apart from each other. In the depicted exemplary embodiment, the dry-construction studs 10, 10′ are formed as vertically arranged dry-construction supports. The dry-construction studs 10, 10′ extend over the entire height of the dry-construction structure 20.

The depicted embodiment shows two different dry-construction studs 10 and 10′. The depicted dry-construction studs 10 are the profiles to which the holders 1 are fastened. In particular, the U-profiles also depicted in the FIGS. 3a to 3f can be used here. In particular, the U-profiles can be reinforced, preferably by being formed as U-stiffening profiles. U-stiffening profiles have a greater sheet thickness than simple U-wall profiles or simple C-wall profiles and are therefore more stable. FIG. 4a also shows other dry-construction studs 10′ to which no holders 1 are fastened. For these, the depicted C-wall profiles can be used in particular. Depending on the size of the loads to be accommodated, the holders 1 can also be used on differently formed dry-construction studs. When using U-stiffening profiles for the dry-construction studs 10 to which the holders 1 are fastened, higher loads can be fastened to the dry-construction structure than it is possible with simple U-wall profiles or simple C-wall profiles.

To achieve guidance and alignment, the dry-construction studs 10, 10′ are inserted in a U-profile 21 which is arranged on the underside of the dry-construction structure in a horizontal direction and connected to the floor. Another U-profile 22 is arranged at the upper end of the dry-construction structure 20 and connected to the ceiling. In this case, the ends of the dry-construction studs 10, 10′ are each accommodated between the legs of the U-profiles 21 or 22 and held thereby.

For a better depiction, the U-profile 22 is partially omitted in FIG. 4a, and the dry-construction stud depicted on the left is depicted in a shortened manner.

The dry-construction structure 20 has the planking 16. In the schematic depiction of FIG. 4a, the planking is depicted as double-layered planking. For a better depiction, the planking 16 is only shown on one side, the side of the dry-construction structure 20 facing the room. In this form, i.e., with planking 16 on one side, the dry-construction structure 20 can be used as a facing shell placed in front of an existing wall (not depicted). However, the dry-construction structure 20 can also have the planking 16 on both sides of the dry-construction studs 10, 10′ to form a partition wall that can be arranged between two rooms.

FIG. 4a further shows that an insulating material 23 can be accommodated between the dry construction studs 10, 10′. For a better representation, the insulating material 23 is only shown in a lower region.

FIG. 4b shows an enlarged cutout of FIG. 4a. Here, it is easy to see how the holder 1 is arranged on the dry-construction stud 10. The arrangement shown in FIG. 4b corresponds to the arrangement also depicted in FIG. 3a. In FIG. 4b, the bolt 3 that is inserted into the connecting body 2 is not depicted for reasons of simplification. FIG. 4b further shows the first fastening elements 13 with which the connecting body 2 is fastened to the dry-construction stud 10.

I addition, FIG. 4a shows that a holder 1 is arranged on each of two adjacent dry-construction studs 10. This way, two fastening points are available for fastening a load. Thus, even larger console loads can be securely fastened.

FIG. 5 shows a cross-section of a dry-construction structure 20′ formed as a partition wall. The dry-construction structure 20′ has substantially the same elements which have been described in connection with the dry-construction structure 20. Reference is made to the description in this regard.

The dry-construction structure 20′ again has vertically arranged dry-construction studs 10. FIG. 5 further shows the holder 1 fastened to the dry-construction stud 10 with the first fastening elements 13. FIG. 5 further shows the bolt 3 of the holder 1 extending through the planking 16.

The dry-construction structure 20′ is arranged between a floor 24 and a ceiling 25. The dry-construction studs 10 are each fastened to the ceiling 25 and the floor 24 by a connecting angle 31. The connection angles 31 are L-shaped and have two legs. One of the legs is connected to the floor 24 or the ceiling 25 via fastening means 51. The other leg of the connecting angle 31 is secured to the dry-construction stud 10.

The dry-construction structure 20′ has a planking 16 on both sides of the dry-construction studs 10. In the depicted exemplary embodiment, the planking is double-layered on both sides. Also depicted are screws 26 used to fasten the planking 16 to the dry-construction studs 10. In addition, the insulating material 23 is also depicted.

FIG. 5 further shows how a schematically depicted load 27 can be fastened to the dry-construction structure 20′. The load 27 is secured to the bolt 3 by means of a fastening mean 28. In the depicted exemplary embodiment, the fastening mean 28 is designed as a nut which is screwed onto the bolt 3.

The FIGS. 4a and 5 further show how a load 27 can be fastened to a dry-construction structure 20 and 20′, respectively, comprising dry-construction studs 10.

The holder 1 is fastened to the dry-construction stud 10 with the first fastening elements 13. The bolt 3 is inserted into the bolt receptacle 7 of the holder 1. A recess 17 for the bolt 3 is made in the planking 16. The planking 16 is fastened to the dry-construction studs 10. This is done in such a way that the bolt 3 of the holder 1 fastened to the dry-construction stud extends through the recess 17 of the planking 16. Finally, the object forming a load 27 can be fastened to the bolt 3.

1. A holder for fastening a load to a dry-construction structure, comprising: a connecting body and a bolt; wherein the connecting body has a first and a second side; wherein an abutment surface for abutting against a dry-construction stud is formed on the first side of the connecting body; and wherein a bolt receptacle for the bolt is provided on the second side of the connecting body.

2. The holder according to claim 1, characterised in that the bolt receptacle has an opening for the bolt.

3. The holder according to claim 1, characterised in that the bolt has an external thread and the bolt receptacle has an internal thread corresponding to the external thread.

4. The holder according to claim 1, characterised in that the bolt receptacle is formed by an annular body which is secured to the connecting body.

5. The holder according to claim 1, characterised by a first fastening element for connecting the connecting body to the dry-construction stud.

6. The holder according to claim 5, characterised in that the connecting body comprises at least one through-opening for the first fastening element.

7. A use of the holder according to claim 1 for securing a load to a dry-construction structure.

8. A kit for a dry-construction system comprising a dry-construction stud, including a holder according to claim 1.

9. The kit according to claim 8, characterised in that the dry-construction stud comprises a profiled body with a web and at least one leg.

10. The kit according to claim 8, characterised in that the web has insertion openings for the first fastening elements.

11. A dry-construction structure, comprising: at least one dry-construction stud and a planking fastened thereto; wherein the planking has a front side and a rear side; wherein the dry-construction stud is arranged at the rear side of the planking; a holder according to claim 1 which is fastened to the dry-construction stud by a first fastening element; and wherein the bolt of the holder extends through the planking from the rear side to the front side.

12. The dry-construction structure according to claim 11, characterised in that the bolt has a section which protrudes by a length from the front side of the planking.

13. The dry-construction structure according to claim 11, characterised in that the planking has a recess, wherein the bolt extends through the recess.

14. A method of fastening an object to a dry-construction structure comprising a dry-construction stud and a planking, comprising the steps of:
fastening of a holder according to claim 1 to the dry-construction stud;
creating a recess in the planking; and
arranging the planking on the dry-construction stud;
wherein this is done in such a way that the bolt of the holder extends through the recess of the planking and wherein the object is fastened to the bolt.
